(19) United States
(12) Patent Application Publication
(10) Pub. No.: US 2014/0085163 A1
(43) Pub. Date: Mar. 27, 2014

(54) COMMUNICATION SYSTEM WITH ANTENNA CONFIGURATION AND METHOD OF MANUFACTURE THEREOF

(71) Applicant: Samsung Electronics Co., Ltd., Gyeonggi-Do (KR)

(72) Inventor: Justin L. Gregg, Golden, CO (US)

(73) Assignee: Samsung Electronics Co., Ltd., Gyeonggi-Do (KR)

(21) Appl. No.: 14/033,969

(22) Filed: Sep. 23, 2013

Related U.S. Application Data
(60) Provisional application No. 61/704,398, filed on Sep. 21, 2012.
(60) Provisional application No. 61/724,865, filed on Nov. 9, 2012.
(60) Provisional application No. 61/725,975, filed on Nov. 13, 2012.

(51) Int. Cl. H01Q 1/12; H01P 11/00

(52) U.S. Cl. CPC H01Q 1/12; H01P 11/001
USPC 343/872; 29/600

(57) ABSTRACT

A communication system includes: a ceramic housing; and a ceramic antenna device attached to the ceramic housing.

### CROSS-REFERENCE TO RELATED APPLICATION(S)

This application claims the benefit of U.S. Provisional Patent Applications Ser. No. 61/704,398 filed Sep. 21, 2012, Ser. No. 61/724,865 filed Nov. 9, 2012, and Ser. No. 61/725,975 filed Nov. 13, 2012, and the subject matters thereof are incorporated herein by reference thereto.

### TECHNICAL FIELD

An embodiment of the present invention relates generally to a communication system, and more particularly to a communication system with a ceramic-based antenna configuration.

### BACKGROUND

Modern consumer and industrial electronics, especially devices such as computers, cellular phones, portable digital assistants, laptops, tablet computers, entertainment devices, and combination devices, are providing increasing levels of functionality to support modern life including wireless communication. Research and development in the existing technologies can take a myriad of different directions.

The growth in functionality has resulted in new uses and increased demand for resources. The increasing levels of functionality, along with growth and adaptation of multiple communication protocols, have increased a demand for increased capacity in wireless communication. Further, a demand for robust devices has also increased.

Thus, a need still remains for a communication system with improved antenna configuration that provides increased signal reception and increased robustness. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a communication system, including: a ceramic housing; and a ceramic antenna device attached to the ceramic housing.

An embodiment of the present invention provides a method of manufacture of a communication system including: providing a ceramic housing; and attaching a ceramic antenna device to the ceramic housing.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an isometric view of a communication system with antenna configuration in an embodiment of the present invention.

FIG. 2 is a bottom view of the communication system.

FIG. 3 is a cross-sectional view of the communication system along a line 2-2 of FIG. 2.

FIG. 4 is a cross-sectional view of the housing portion in a casing phase of manufacturing.

FIG. 5 is a cross-sectional view of the antenna unit in an antenna phase of manufacturing.

FIG. 6 is a cross-sectional view of the housing portion and the antenna unit in an integration phase of manufacturing.

FIG. 7 is a cross-sectional view of the communication system of FIG. 1 in an assembly phase of manufacturing.

FIG. 8 is a cross-sectional view of a communication system with antenna configuration in a second embodiment of the present invention.

FIG. 9 is a bottom view of the dielectric resonator antenna.

FIG. 10 is a side view of the dielectric resonator antenna.

FIG. 11 is a functional block diagram for the communication system.

FIG. 12 is a flow chart of a method of manufacture of a communication system in an embodiment of the present invention.

### DETAILED DESCRIPTION

An embodiment of the present invention includes a ceramic housing directly attached to or integrated with a ceramic antenna device. The direct attachment between the ceramic antenna device and the ceramic housing provides increased functionalities for receiving and transmitting radio frequency signals, increased physical robustness, and decrease in volume required for resulting overall system.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

Where multiple embodiments or manufacturing processes are disclosed and described, having some features in common, similar or like features in multiple drawing figures will ordinarily be described with similar reference numerals for clarity and ease of illustration, description, and comprehension thereof. For multiple embodiments, the embodiments have been sequenced, such as using first embodiment and second embodiment, as a matter of descriptive convenience and are not intended to have any other significance or provide limitations for the present invention.

For descriptive purposes, the term “horizontal” as used herein is defined as a plane parallel to the plane or surface of an interfacing portion, such as a screen or an input portion, regardless of its orientation. The term “vertical” refers to a direction perpendicular to the horizontal as just defined. Terms, such as “above”, “below”, “bottom”, “top”, “side”, “higher”, “lower”, “upper”, “over”, and “under are defined with respect to the horizontal plane, as shown in the figures. The term “on” means that there is direct contact among elements without having intervening materials.

The term “processing” as used herein includes attaching or removing material, forming or shaping material, heating, cooling, cleaning, as required in manufacturing a described structure.

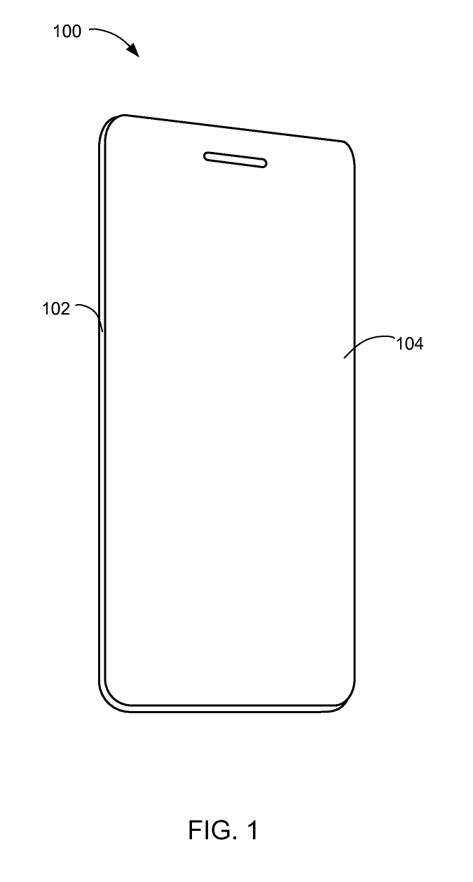

Referring now to FIG. 1, therein is shown an isometric view of a communication system 100 with antenna configuration in an embodiment of the present invention. The communication system 100 can include a variety of devices, such as a cellular phone, a personal digital assistant, a smart phone, a notebook computer, a tablet computer, a wearable device, an entertainment device, or a combination thereof. The communication system 100 can further include or couple with a server, a base station, a switch, a router, or a combination thereof.

The communication system 100 can include a housing portion 102 and an interface portion 104. The housing portion 102 is a covering structure on the exterior of the communication system 100. The housing portion 102 can be a decorative structure, a protective structure, or a combination thereof. The housing portion 102 can surrounding or support components. The housing portion 102 can be connected to the interface portion 104. The housing portion 102 can further provide support for the interface portion 104.

The interface portion 104 is a part of the communication system 100 for exchanging information with the user. The interface portion 104 can include a display screen, a keyboard, a speaker, a touch screen, or a combination thereof. The interface portion 104 and the housing portion 102 can form exterior surface of the communication system 100. The interface portion 104 and the housing portion 102 can surround, encase, cover, or a combination thereof for components of the communication system 100.

For illustrative purposes, the communication system 100 is shown as a smartphone device. However, it is understood that the communication system 100 can be a different device, such as a tablet computer, a laptop computer, an entertainment device or a gaming device, or a combination thereof. It is also understood that the communication system 100 can include or couple to other devices, such as a server, a base station, a router, or a combination thereof.

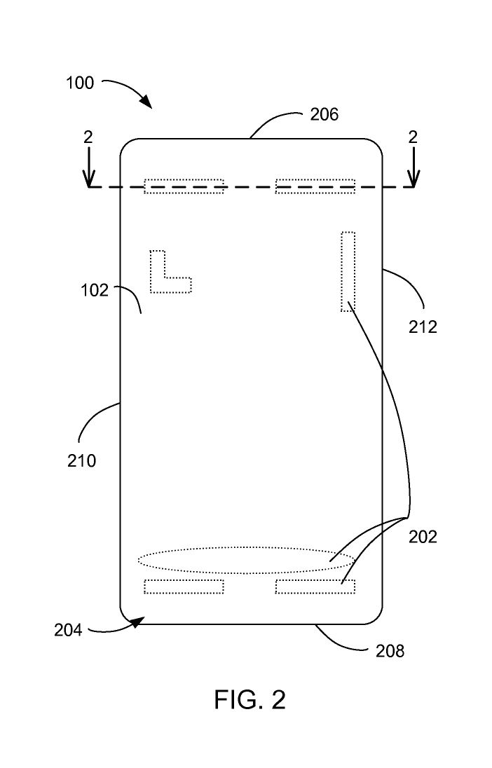

Referring now to FIG. 2, therein is shown a bottom view of the communication system 100. The bottom view can show the housing portion 102 and an antenna location 202. The antenna location 202 can be a position or a locality for a device for receiving or sending wireless communication signals. The device for receiving or sending the wireless signals can be on an interior surface of the housing portion 102 or located internal to the communication system 100.

The antenna location 202 can include a shape according to the device accommodating wireless signals. For example, the antenna location 202 can have a shape of a substantially rectangular or square shape, a circle or an ellipse, ‘L’ shape, or a combination thereof.

The communication system 100 can have an antenna arrangement 204 for controlling orientation of the antenna location 202 or controlling placement of multiple instances of the antenna location 202. The antenna arrangement 204 can have various shapes and locations.

For example, the antenna arrangement 204 have more than one instances of the antenna location 202 having rectangular shapes along or parallel to a first edge 206 of the housing portion 102 or a second edge 208 of the housing portion 102, closer to the first edge 206 than the second edge 208 or closer to the second edge than the first edge 206, or a combination thereof. Also for example, the antenna location 202 can have multiple instances of the antenna location 202 each having different shapes along or parallel to a third edge 210 of the housing portion 102 or a fourth edge 212 of the housing portion 102, closer to the third edge 210 than the fourth edge 212 or closer to the fourth edge 212 than the third edge 210, or a combination thereof. For further example, the antenna arrangement 204 can have a longer side or axis of the antenna location 202 along or parallel to the first edge 206, the second edge 208, the third edge 210, the fourth edge 212, or a combination thereof.

The antenna arrangement 204 can be based on a function, a protocol, a standard or a regulatory specification, a feature, or a combination thereof associated with the wireless signal device or a grouping thereof. The antenna arrangement 204 can further correspond to a communication counterpart, such as a base station or a router, a carrier frequency, a communication range, or a combination thereof.

For example, the antenna arrangement 204 can be specific for wireless fidelity (WiFi) communication with a hotspot or a router using a corresponding carrier frequency or bandwidth. Also for example, the antenna arrangement 204 can correspond to communication with a global positioning system (GPS). For further example, the antenna arrangement 204 can be based on a Fourth Generation (4G) or a Long Term Evolution (LTE) wireless communication protocol or standard.

The first edge 206 can abut the third edge 210, the fourth edge 212, or a combination thereof. The first edge 206 can be opposite to, parallel to, or a combination thereof in relation to the second edge 208. The third edge 210 can be opposite to, parallel to, or a combination thereof in relation to the fourth edge 212.

For illustrative purposes, the communication system 100 is described as a device having a rectangular arrangement of four edges. However, it is understood that the communication system 100 can have a different shape with a different arrangement or number of edges. For example, the communication system 100 can have a perimeter having an oval shape. Also for example, the first edge 206, the second edge 208, or a combination thereof can be a curved edge, such as concave or convex.

The communication system 100 can include ceramic material. The ceramic material can be inorganic, nonmetallic materials associated with processing or use at high temperature. The ceramic material can include oxides, nitrides, borides, carbides, silicides, sulfides, or a combination thereof. The ceramic material can further include conductive or nonconductive material such as intermetallic compounds including aluminides, beryllides, phosphides, antimonides, arsenides, or a combination thereof. Various aspects of the ceramic material, such as content or composition, processing steps for the ceramic material, or a combination thereof can be controlled to achieve desired characteristics, such as hardness, density, temperature-based behavior, electrical characteristic, or a combination thereof.

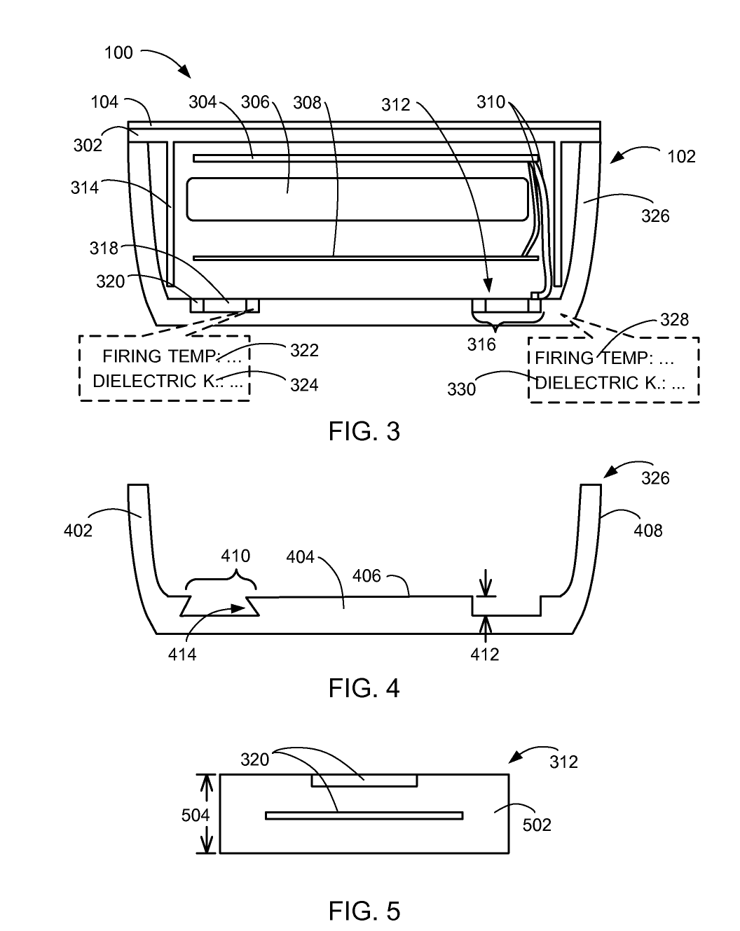

Referring now to FIG. 3, therein is shown a cross-sectional view of the communication system 100 along a line 2-2 of FIG. 2. The communication system 100 can include the interface portion 104, a cover frame 302, a circuit board 304, a battery 306, a grounding flex 308, an interconnect 310, an antenna unit 312, or a combination thereof.

The interface portion 104 can be a glass cover, a silicon cover, a plastic cover, or a combination thereof. The interface portion 104 can include an electronic circuit component, such as an organic light emitting diode (OLED) or a sensor component. The interface portion 104 can display images, sense a contact from a user's hand or finger, or a combination thereof. The interface portion 104 can provide an external surface on the top portion of the communication system 100.

The interface portion 104 can be on the cover frame 302 using mechanical attachments or attached to the cover frame 302 using an adhesive. The interface portion 104 can be over the cover frame 302. The interface portion 104 can also be attached to the housing portion 102 and horizontally extend between the third edge 210 of FIG. 2 and the fourth edge 212 of FIG. 2 of the housing portion 102.

The cover frame 302 is a structure for providing support for the communication system 100. The cover frame 302 can provide structural support for relative location, orientation, spacing, or a combination thereof for components within the communication system 100. The cover frame 302 can further provide structural integrity, rigidity, or a combination thereof for the communication system 100. The cover frame 302 can be a metal frame having electrically conductive characteristic, electro-magnetic interference (EMI) shielding characteristic, or a combination thereof.

The cover frame 302 can be over the housing portion 102 or between the third edge 210 and the fourth edge 212 of the housing portion 102. The cover frame 302 can extend horizontally from the third edge 210 and the fourth edge 212, or extend horizontally within the housing portion 102 between the third edge 210 and the fourth edge 212. The cover frame 302 can further include vertical extensions 314 extending in a downward direction.

The cover frame 302 can be over the circuit board 304. The circuit board 304 can be between the vertical extensions 314 of the cover frame 302.

The circuit board 304 can be a panel including a specific collection of electronic components connected to perform a process. For example, the circuit board 304 can include a printed circuit board (PCB), a strip board, a processor, electronic packaging, a passive component, or a combination thereof. The circuit board 304 can include the specific combination of components for performing the features or the functions of the communication system 100.

The battery 306 can be a device or a component that stores electrical energy and provides such energy for operating the communication system 100. The battery 306 can include a lithium ion battery. The battery 306 can be between the cover frame 302 and the housing portion 102. The battery 306 can be between the vertical extensions 314 of the cover frame 302. The battery 306 can be connected to the circuit board 304 through the interconnect 310 for providing energy to the circuit board 304.

The grounding flex 308 can be a structure for providing an electrical reference point and a source or a sink for electrical radio frequency currents for the communication system 100. The grounding flex 308 can be a metal structure or can include metal therein. The grounding flex 308 can also be electrically conductive.

The grounding flex 308 can be between the cover frame 302 and the housing portion 102. The grounding flex 308 can be over the antenna location 202 of FIG. 2 according to the antenna arrangement 204 of FIG. 2. The grounding flex 308 can be between the cover frame 302 and the antenna location 202. The grounding flex 308 can provide electro-magnetic interference or radiation shielding for the user using the communication system 100. The grounding flex 308 can shape the density pattern of radiating energy or fields from the antenna location 202.

The grounding flex 308 can be connected to the circuit board 304 through the interconnect 310 for providing an electrical ground for the circuit board 304. The interconnect 310 may be comprised of a coaxial type cable or wire system electrically conducting both the antenna radio frequency signal and ground signal

The antenna unit 312 can be an electrical device for converting or radiating electric power to wireless signals, including radio frequency signals. The antenna unit 312 can convert digital or analog information used within the communication system 100 to or from electro-magnetic signals for wirelessly traversing space. The antenna unit 312 can transmit by generating wireless signals, including radiating energy. The antenna unit 312 can receive wireless signals by detecting the electro-magnetic signals for converting the signals to electrical currents.

The antenna unit 312 can be between the housing portion 102 and the cover frame 302, the grounding flex 308, or a combination thereof. The antenna unit 312 can be attached to the housing portion 102. The antenna unit 312 can be located at the antenna location 202 according to the antenna location 202. The antenna unit 312 can have a shape, an orientation, or a combination thereof corresponding to the antenna location 202. The antenna unit 312 can be connected to the circuit board 304 through the interconnect 310 for transmitting or receiving wireless signals.

The antenna unit 312 can include a specific function, protocol, feature, the communication counterpart, the carrier frequency, the communication range, or a combination thereof. For example, the antenna unit 312 can correspond to communicating with a GPS device or satellite, a router, a base station, another device, or a combination thereof.

The communication system 100 can include a ceramic antenna device 316 for the antenna unit 312. The ceramic antenna device 316 is the antenna unit 312 including the ceramic material. The ceramic antenna device 316 can be low temperature co-fired ceramic (LTCC) antenna. The ceramic antenna device 316 can include a ceramic-portion 318 and a circuitry-portion 320.

The ceramic antenna device 316 can include the ceramic-portion 318 as a substrate for the circuitry-portion 320. The ceramic-portion 318 can be below the circuitry-portion 320. The ceramic antenna device 316 can further include the ceramic-portion 318 surrounding the circuitry-portion 320 or enclosing the circuitry-portion 320 or a portion thereof. The circuitry-portion 320 can be connected or otherwise coupled to the interconnect 310.

The ceramic antenna device 316 can further include ceramic material having antenna-specific characteristics, such as an antenna-processing temperature 322 and an antenna-dielectric characteristic 324. The antenna-processing temperature 322 is a description of thermal energy required for processing the ceramic-portion 318 of the ceramic antenna device 316. The antenna-processing temperature 322 can be the firing temperature for sintering the ceramic-portion 318 of the ceramic antenna device 316. The antenna-processing temperature 322 for the ceramic antenna device 316 can be less than 1,000 degrees Celsius for the LTCC antenna.

The antenna-dielectric characteristic 324 is a measurement of electrically isolative or conductive property for the ceramic antenna device 316. The antenna-dielectric characteristic 324 can be represented as a dielectric constant. The antenna-dielectric characteristic 324 can correspond to the ceramic-portion 318 of the ceramic antenna device 316. The ceramic-portion 318 can include ceramic material having the antenna-dielectric characteristic 324 representing an electrical insulator and having a relatively high value for the antenna-dielectric characteristic 324. As a more specific example, the high-k of ceramic housing will boost the effective-k of the LTCC antenna.

The circuitry-portion 320 can include an electrically conductive material, such as metal, for receiving or transmitting the wireless signals. The circuitry-portion 320 can include a size, a shape, an arrangement, a characteristic, or a combination thereof based on the antenna-dielectric characteristic 324, the housing portion 102, the grounding flex 308, or a combination thereof for the electrically conductive material.

The communication system 100 can include a ceramic housing 326 for the housing portion 102. The ceramic housing 326 is a cover structure including ceramic material forming the exterior of the communication system 100. The ceramic housing 326 can include the ceramic material in the entirety or a portion of the structure.

The ceramic housing 326 can include the ceramic material having housing-specific characteristics, such as a housing-processing temperature 328 and a housing-dielectric characteristic 330. The housing-processing temperature 328 is a description of thermal energy required for processing the ceramic housing 326. The housing-processing temperature 328 can be the firing temperature for sintering the ceramic housing 326.

The housing-processing temperature 328 can be higher than the antenna-processing temperature 322. The housing-processing temperature 328 can be greater than 1000 degrees Celsius, such as 1,600 or 10,000 degrees Celsius.

The housing-dielectric characteristic 330 is a measurement of electrically isolative or conductive property for the ceramic housing 326. The housing-dielectric characteristic 330 can be represented as a dielectric constant. The ceramic housing 326 can include ceramic material having the housing-dielectric characteristic 330 resenting an electrical insulator and having a relatively high value for the housing-dielectric characteristic 330. The housing-dielectric characteristic 330 can be greater than, less than, or equal to the antenna-dielectric characteristic 324.

It has been discovered that the communication system 100 including the ceramic housing 326 provides increased structural integrity and robustness. The ceramic housing 326 can include physical characteristics for maintaining shape, consistency, operability, or a combination thereof during application of physical force or shock, such as in collisions with other objects.

The ceramic antenna device 316 can be attached to the ceramic housing 326. The ceramic antenna device 316 can be attached directly to the ceramic housing 326 using adhesive or additional ceramic material and without any other intervening material or structure there-between. The ceramic antenna device 316 can further be directly attached to the ceramic housing 326 using a mechanical attachment, such as a fastener or interlocking structural shapes, and without any intervening material or structure in addition to possible adhesive material there-between.

It has been discovered that the ceramic antenna device 316 attached directly to the ceramic housing 326 provides increased efficiency for transmitting and receiving wireless signals. The dielectric characteristic surrounding the antenna unit 312 resulting from the ceramic housing 326 can improve the operational efficiency of the antenna unit 312. The improved efficiency of the antenna unit 312 can further result in decrease in size thereof, leading to decrease in size for the communication system 100.

The ceramic antenna device 316 can be integrated directly into the ceramic housing 326 with the ceramic housing 326 surrounding or encasing the ceramic antenna device 316. It has been discovered that the ceramic antenna device 316 integrated into the ceramic housing 326 provides simpler manufacturing process with increased performance for transmitting and receiving the wireless signal. The integration provides attachment along with consistency in material across the ceramic housing 326 and the ceramic antenna device 316.

Further, it has been discovered that the usage of the ceramic material through the ceramic antenna device 316 and the ceramic housing 326 provides high dielectric environment for increasing the performance of the antenna. The high dielectric environment can be robust and prevent significant changes in load from the user of the device, and reduce the impact on the antenna performance from the user.

Referring now to FIG. 4, therein is shown a cross-sectional view of the housing portion 102 in a casing phase of manufacturing. The housing portion 102 can include the ceramic housing 326. The ceramic housing 326 can be made of the ceramic material in its entirety or include the ceramic material within a portion therein.

The ceramic housing 326 can be provided by forming, receiving, placing, conditioning, or a combination of processes thereof for the ceramic housing 326. For example, the ceramic housing 326 can be formed by controlling the ceramic material. The ceramic material can be controlled to form the ceramic housing 326 including the housing-processing temperature 328 of FIG. 3, the housing-dielectric characteristic 330 of FIG. 3, specific rigidity or hardness, or a combination thereof. The ceramic material can be shaped, and heated, fired, sintered, or a combination thereof based on the housing-processing temperature 328 to form the ceramic housing 326.

Also for example, the ceramic housing 326 can also be provided with the ceramic housing 326 already formed for various phases of the manufacturing process. For further example, the ceramic housing 326 can be provided by controlling the physical location of the ceramic housing 326 during the various phases of the manufacturing process, conditioning or treating the ceramic housing 326, or a combination thereof.

The ceramic housing 326 can include vertical portions 402 abutting and extending above a bottom planar portion 404. The ceramic housing 326 can include a concaved space between the vertical portions 402 and the bottom planar portion 404.

The vertical portions 402 can extend away from each other, curve toward each other, extend upward from the bottom planar portion 404, or a combination thereof. The vertical portions 402 can be integral with the bottom planar portion 404. The vertical portions 402 and the bottom planar portion 404 can integrally form an angle or a smooth concave junction.

The ceramic housing 326 can include an inner surface 406 and an outer surface 408. The inner surface 406 can on top or inside portions for the vertical portions 402, the bottom planar portion 404, or a combination thereof. The inner surface 406 can be planar and horizontal for the bottom planar portion 404. The outer surface 408 can be opposite the inner surface 406.

The ceramic housing 326 can include a pocket 410. The pocket 410 is a depression extending from the inner surface 406 toward the outer surface 408. The pocket 410 can extend from the inner surface 406 and form an integral concave surface with the inner surface 406. The pocket 410 on the bottom planar portion 404 can be a depression in the inner surface 406 with the pocket 410 extending downward from a top portion of the bottom planar portion 404.

The ceramic housing 326 can be formed or provided having the pocket 410 thereon, such as by shaping, molding, heating, firing, sintering, or a combination thereof. The pocket 410 can be based on the antenna arrangement 204 of FIG. 2, the antenna location 202 of FIG. 2, or a combination thereof. The pocket 410 can be shaped, located, oriented, or a combination thereof according to the antenna arrangement 204, the antenna location 202, or a combination thereof.

The pocket 410 can be further formed on the ceramic housing 326, such as by cutting, carving, machining, chemically removing, eroding, or a combination of processes thereof. The pocket 410 can be formed according to the antenna arrangement 204, the antenna location 202, or a combination thereof.

The pocket 410 can have a pocket depth 412, a locking shape 414, or a combination thereof. The pocket depth 412 is a measure of distance for the amount of depression from the inner surface 406. The pocket depth 412 can be measured along a direction orthogonal to the inner surface 406, the outer surface 408, or a combination thereof at the pocket 410 or at a point adjacent to the pocket 410.

The locking shape 414 is a geometric shape of the pocket 410 for containing objects placed therein. The locking shape 414 can be used to provide mechanical attachment or containment for objects placed therein. The locking shape 414 can account for changes in size, shape, or a combination thereof for the ceramic housing 326 or any objects placed or attached therein during the manufacturing process. The locking shape 414 can be for utilizing interference fit.

Referring now to FIG. 5, therein is shown a cross-sectional view of the antenna unit 312 in an antenna phase of manufacturing. The antenna unit 312 can include the ceramic antenna device 316 of FIG. 3. The ceramic antenna device 316 can include a low temperature co-fired ceramic antenna 502. The ceramic antenna device 316 can include the ceramic material.

The ceramic antenna device 316 can be provided separate from the ceramic housing 326 of FIG. 3. The ceramic antenna device 316 can be by forming, receiving, placing, conditioning, or a combination of processes thereof for the ceramic antenna device 316.

For example, the ceramic antenna device 316 can be form by controlling the ceramic material. The ceramic material can be controlled to form the ceramic-portion 318 of FIG. 3 of the ceramic antenna device 316 including the antenna-processing temperature 322 of FIG. 3, the antenna-dielectric characteristic 324 of FIG. 3, specific rigidity or hardness, or a combination thereof. The ceramic material can be controlled to include the antenna-processing temperature 322 less or lower than the housing-processing temperature 328 of FIG. 3.

Continuing with the example, the ceramic material can be shaped, and heated, fired, sintered, or a combination thereof based on the housing-processing temperature 328 to form the ceramic antenna device 316. The circuitry-portion 320 can be formed on, within, or a combination thereof relative to the ceramic-portion 318, before or after the processing for the ceramic material, to form the ceramic antenna device 316.

The circuitry-portion 320 can include an antenna structure, such as a meandering 1/4 wave dipole structure, a folded inverted F antenna (FIFA) structure, an inverted-F structure, or a stripline structure. The circuit-portion 320 can further include an external pad, traces, vias, passive components, active components, or a combination thereof connected to the antenna structure.

Also for example, the ceramic antenna device 316 can also be provided with the ceramic antenna device 316 already formed for the manufacturing process. For further example, the ceramic antenna device 316 can be provided by controlling the physical location of the ceramic antenna device 316 during the manufacturing process, conditioning or treating the ceramic antenna device 316, or a combination thereof.

The ceramic antenna device 316 can include an antenna height 504. The antenna height 504 can be a measure of distance from a top portion of the ceramic antenna device 316 to a bottom portion of the ceramic antenna device 316. The top portion of the ceramic antenna device 316 can include the circuitry-portion 320 or an exposure thereof for providing electrical connection.

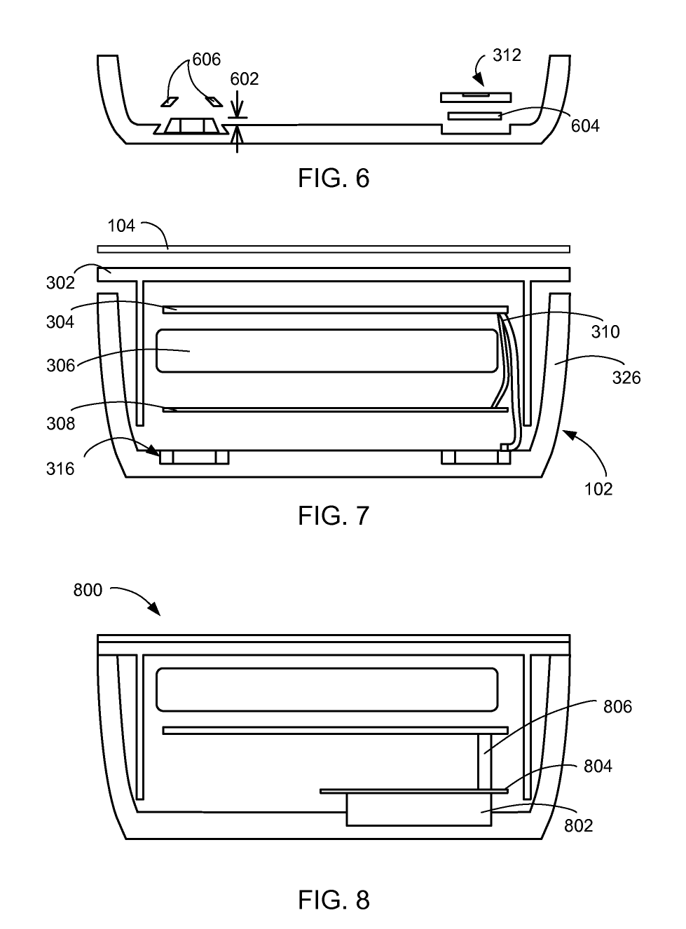

Referring now to FIG. 6, therein is shown a cross-sectional view of the housing portion 102 and the antenna unit 312 in an integration phase of manufacturing. The integration phase can integrate the antenna unit 312 and the housing portion 102 of FIG. 1.

The ceramic antenna device 316 of FIG. 3 can be attached to the ceramic housing 326 of FIG. 3. The ceramic antenna device 316 can be attached to the inner surface 406 of FIG. 4 of the ceramic housing 326 or in the pocket 410 of FIG. 4 of the ceramic housing 326.

It has been discovered that the ceramic antenna device 316 attached to the ceramic housing 326 provides increased robustness and increased performance for the ceramic antenna device 316. The ceramic housing 326 provides an environment with high dielectric constant around the ceramic antenna device 316, which can increase the electrical functions of the ceramic antenna device 316. Further the ceramic housing 326 with the high dielectric constant can minimize the effect from other materials contacting the communication system 100 of FIG. 1, such as the user's hand.

It has also been discovered that the ceramic antenna device 316 attached to the ceramic housing 326 can decrease the size of the communication system 100. The increase in the dielectric constant for the surrounding environment can increase the efficiency of the circuitry-portion 320 of FIG. 3 and reduce the sizing of thereof, leading to a decrease in the overall sizing.

The ceramic antenna device 316 can be embedded into the ceramic housing 326 by attaching in the pocket 410. The ceramic antenna device 316 can be embedded into the ceramic housing 326 having a bottom portion of the ceramic antenna device 316 below the inner surface 406 and in the ceramic housing 326.

The ceramic antenna device 316 can have a protrusion height 602 after being attached to the ceramic housing 326 in the pocket 410. The protrusion height 602 can be a measure of distance between the inner surface 406 and a top portion of the ceramic antenna device 316. The ceramic antenna device 316 can extend above the inner surface 406 by the protrusion height 602. The protrusion height 602 can be based on the pocket depth 412 of FIG. 4 and the antenna height 504 of FIG. 5, or a difference there-between.

It has been discovered that the ceramic antenna device 316 embedded in the ceramic housing 326 provides decrease in overall size of the communication system 100. Attaching the ceramic antenna device 316 in the pocket 410 can decrease the protrusion height 602 by the pocket depth 412, which can lead to a decrease in vertical space required for all circuitry and components, and thereby reduce the profile height for the overall structure. A volume required for the antenna unit 312 can be shared with a volume required for the ceramic housing 326 with the pocket 410.

It has also been discovered that the ceramic antenna device 316 embedded in the ceramic housing 326 provides increased reliability for the ceramic antenna device 316. Surrounding the ceramic antenna device 316 with further instance of the ceramic material provides improved dielectric property for the material surrounding the circuitry-portion 320 of FIG. 3 of the ceramic antenna device 316. The improved dielectric property increases the overall electrical functionality of the ceramic antenna device 316.

The ceramic antenna device 316 can be attached to the ceramic housing 326 using various mechanisms. For example, the ceramic antenna device 316 can be attached using an adhesive 604, such as industrial glue type of material or resin. The adhesive 604 can harden or adhere based on chemical reaction and passage of time, exposure to light or a gas, or a combination thereof. The adhesive 604 can be a conformal fill or a planar sheet.

Continuing with the example, the adhesive 604 can be placed in the pocket 410 or on the inner surface 406. The ceramic antenna device 316 can be placed on the adhesive 604, having the adhesive 604 between the ceramic housing 326 and the ceramic antenna device 316. The adhesive 604 can be activated, such as by a catalyst or exposure to light, to attach the ceramic antenna device 316 to the ceramic housing 326.

Also for example, the ceramic antenna device 316 can be attached using an additional ceramic-material 606. The additional ceramic-material 606 can be an instance of the ceramic material separate from the ceramic antenna device 316 and the ceramic housing 326. The additional ceramic-material 606 can be made of the ceramic material similar to the ceramic antenna device 316. The additional ceramic-material 606 can have a processing temperature lower than the housing-processing temperature 328 of FIG. 3 or the antenna-processing temperature 322 of FIG. 3. The additional ceramic-material 606 can include a conformal fill or a planar sheet.

Continuing with the example, the additional ceramic-material 606 can be placed in the pocket 410 or on the inner surface 406. The ceramic antenna device 316 can be placed on the additional ceramic-material 606, having the additional ceramic-material 606 between the ceramic housing 326 and the ceramic antenna device 316.

For further example, the ceramic antenna device 316 can be attached using the locking shape 414 of FIG. 4. The ceramic antenna device 316 can have a shape corresponding or complementing the locking shape 414. The ceramic antenna device 316 can also be formed in the pocket 410 having the locking shape 414. The locking shape 414 can mechanically attach the ceramic antenna device 316 to the ceramic housing 326. Formation of the ceramic antenna device 316 will be described further below.

The ceramic antenna device 316 can be attached directly to the ceramic housing 326. The ceramic antenna device 316 can be directly attached by having only the adhesive 604 or the additional ceramic-material 606 between the ceramic housing 326 and the ceramic antenna device 316. The ceramic antenna device 316 can further be directly attached by having the ceramic antenna device 316 directly on or physically contacting the ceramic housing 326.

A glaze or a coating can be applied over the ceramic housing 326, the ceramic antenna device 316, or a combination thereof. The glaze or the coating can be for further conditioning the structure, providing a protective layer, providing a design or an appearance, or a combination thereof.

The ceramic housing 326, the ceramic antenna device 316, or a combination thereof can be further processed. The ceramic housing 326, the ceramic antenna device 316, or a combination thereof can be heated, fired, sintered, or a combination thereof. The ceramic housing 326, the ceramic antenna device 316, or a combination thereof can be heated, fired, sintered, or a combination thereof based on the antenna-processing temperature 322 of FIG. 3, a temperature less than or below the housing-processing temperature 328 of FIG. 3.

The ceramic-portion 318 of the ceramic antenna device 316, the additional ceramic-material 606, or a combination thereof can be affected by the further processing. For example, the ceramic antenna device 316, the additional ceramic-material 606, or a combination thereof can be reformed or reshaped, attached or integrated into the ceramic housing 326, or a combination thereof. The ceramic material for the ceramic antenna device 316 and the ceramic housing 326 can be on each other or contact each other, be integral with each other, or a combination thereof.

It has been discovered that the ceramic antenna device 316 integrated into the ceramic housing 326 provides improved signal processing for the communication system 100. The integration of the ceramic material around the circuitry-portion 320 of the ceramic antenna device 316 provides material having a high dielectric constant surrounding the circuitry-portion 320, improving the transmission and the reception of the ceramic antenna device 316. Further the ceramic material reduces the shift in dielectric properties during usage of the communication system 100.

It has further been discovered that the ceramic antenna device 316 and the ceramic housing 326 provide improved efficiency in manufacturing the communication system 100. The ceramic antenna device 316 can be processed using a firing or a heating step required for processing the ceramic housing 326.

The further processing step for reforming or reshaping, attaching or integrating, or a combination thereof for the ceramic antenna device 316 and the ceramic housing 326 can alternatively be combined with another manufacturing step. For example, the integration phase of manufacturing shown in FIG. 6 can be combined with the antenna phase of manufacturing for forming the ceramic antenna device 316 shown in FIG. 5.

Continuing with the example, the ceramic antenna device 316 can be formed in the pocket 410. The ceramic antenna device 316 can be shaped, combined, attached, or a combination thereof with the last instance of the firing, heating, sintering, or a combination thereof in the integration phase of manufacturing.

It has been discovered that the ceramic antenna device 316 formed in the pocket 410 provides increased efficiency for manufacturing the communication system 100. The formation of the ceramic antenna device 316 in the pocket 410 can utilize processing steps required for integrating and manufacturing the ceramic housing 326 for the communication system 100. Further, it has been discovered that the ceramic antenna device 316 formed in the pocket 410 provides increase in attachment strength and integration between the ceramic antenna device 316 and the ceramic housing 326.

Referring now to FIG. 7, therein is shown a cross-sectional view of the communication system 100 of FIG. 1 in an assembly phase of manufacturing. The ceramic housing 326 having the ceramic antenna device 316 can be aligned with other structural components, such as the circuit board 304, the grounding flex 308, the cover frame 302, the interface portion 104, the battery 306, the interconnect 310, or a combination thereof. The other structural components can be attached or assembled to each other first and then attached to the housing portion 102. The other structural components can further be attached to the housing portion 102 first and assembled based on such attachment.

It has been discovered that attaching the ceramic antenna device 316 to the ceramic housing 326 before attaching the other structural components reduces the complexity in the manufacturing process. Aligning the ceramic antenna device 316 having a relatively small size first to the ceramic housing 326 having a larger size before assembling and attaching the larger devices provide simpler processes than attaching the ceramic antenna device 316 after assembling and attaching the other structural components.

Referring now to FIG. 8, therein is shown a cross-sectional view of a communication system 800 with antenna configuration in a second embodiment of the present invention. The communication system 800 can include the interface portion 104 of FIG. 1, the cover frame 302 of FIG. 3, the circuit board 304 of FIG. 3, the battery 306 of FIG. 3, the antenna unit 312 of FIG. 3, or a combination thereof as described above.

The interface portion 104 can be on or attached to the cover frame 302, the housing portion 102 of FIG. 1, or a combination thereof as described above. The battery 306 can be between the cover frame 302 and the housing portion 102. The circuit board 304 can be between the battery 306 and the housing portion 102.

The communication system 800 can further include the antenna unit 312 embedded in the housing portion 102 as described above. The antenna unit 312 can include a dielectric resonator antenna (DRA) 802. The dielectric resonator antenna 802 is the antenna unit 312 including the ceramic material, a dielectric resonator, or a combination thereof. The ceramic material can include the dielectric resonator. The dielectric resonator antenna 802 can include a “chip antenna”. The dielectric resonator antenna 802 can have a larger size than the low temperature co-fired ceramic antenna 502 of FIG. 5.

The low temperature co-fired ceramic antenna 502 is optional for the dielectric resonator antenna 802. The dielectric resonator antenna 802 can utilize higher-k materials without the addition or inclusion into a high-k ceramic housing. The dielectric resonator antenna 802 configured separate from the housing can enable different, hard to mold, structure or shapes for the ceramic body for the dielectric resonator antenna 802.

The dielectric resonator antenna 802 can include one or more resonator blocks. The dielectric resonator antenna 802 can include one or more feed lines external to the resonator blocks and not embedded into the resonator blocks.

The dielectric resonator antenna 802 can include a multi-feed DRA. The dielectric resonator antenna 802 can include resonant modes for creating the radiation. The dielectric resonator antenna 802 can resonate in one or more frequency band or include one or more resonant modes. The multi-feed DRA, the resonant modes, or a combination thereof can be controlled by controlling a composition, a structure, a dimension, or a combination thereof for the dielectric resonator antenna 802.

The dielectric resonator antenna 802 can further include the antenna-processing temperature 322 of FIG. 3, the antenna-dielectric characteristic 324 of FIG. 3, the antenna height 504 of FIG. 5, or a combination thereof. The antenna-processing temperature 322, the antenna-dielectric characteristic 324, or a combination thereof can be controlled by controlling the composition of the ceramic material. The antenna height 504 can be controlled by shaping or sizing the dielectric resonator antenna 802.

The communication system 800 can include a micro-strip 804 on or directly attached to the dielectric resonator antenna 802. The dielectric resonator antenna 802 can further include the micro-strip 804. The micro-strip 804 can be on a top portion of the dielectric resonator antenna 802.

The micro-strip 804 is an electrical transmission line. The micro-strip 804 can convey wireless signals, including radio frequency signals or microwave signals. The micro-strip 804 can be separate from a grounding plane, including the grounding flex 308 of FIG. 3. The micro-strip 804 can include metallic material, intermetallic material, or a combination thereof.

The communication system 800 can include the interconnect 310 connecting or coupling the circuit board 304 and the micro-strip 804, the dielectric resonator antenna 802, or a combination thereof. The interconnect 310 can include a feed 806. The feed 806 can convey the wireless signals between the circuit board 304 and the micro-strip 804, the dielectric resonator antenna 802, or a combination thereof.

The dielectric resonator antenna 802, the micro-strip 804, or a combination thereof can be designed based on dielectrically loaded chip-type antenna. The dielectric resonator antenna 802 can further be embedded or integrated into the ceramic housing 326 of FIG. 3 as described above.

It has been discovered that the dielectric resonator antenna 802 dielectrically loaded and embedded or integrated into the ceramic housing 326 provides increased reliability and robustness in wireless communications. The dielectric resonator antenna 802 and the ceramic housing 326 provide higher dielectric constant than the housing portion 102 made of common plastic type material. The higher dielectric constant reduces shifts in dielectric characteristic for the overall device and improves the transmission and reception capabilities of the antenna unit 312.

It has been discovered that the dielectric resonator antenna 802 embedded or integrated into the ceramic housing 326 provides longer battery life for the communication system 100. The reduction in the protrusion height 602 can allow for increase in size and capacity for the battery 306.

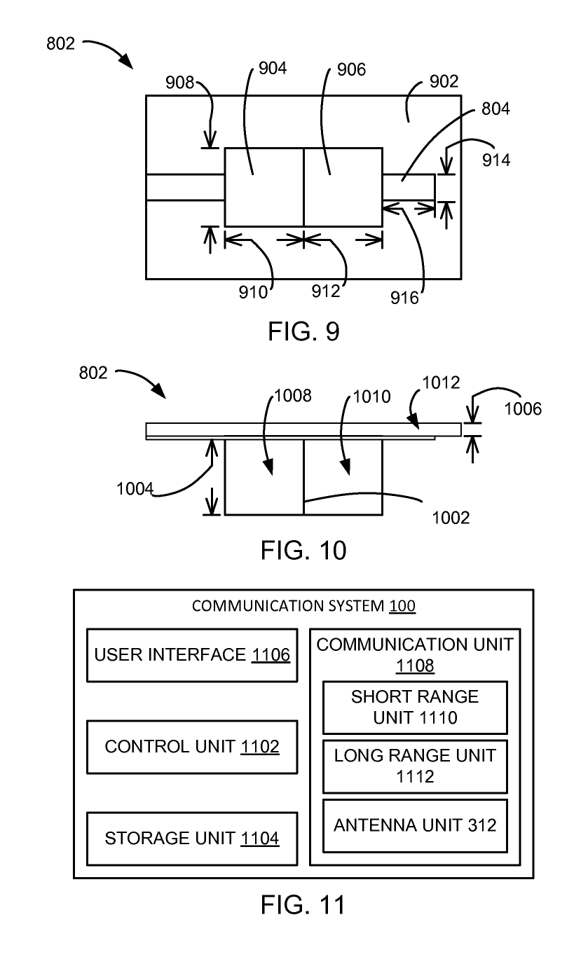

Referring now to FIG. 9, therein is shown a bottom view of the dielectric resonator antenna 802. The dielectric resonator antenna 802 can include a grounding plane 902, a resonator portion 904, a further portion 906, or a combination thereof. The resonator portion 904, the further portion 906, or a combination thereof can be on or attached to the grounding plane 902. The micro-strip 804 can be on or attached to the resonator portion 904, the further portion 906, the grounding plane 902, or a combination thereof.

The micro-strip 804 can be on or attached to a top surface or a bottom surface of the grounding plane 902. The micro-strip 804 can horizontally extend from a center portion of the grounding plane 902 toward an edge of the grounding plane 902, and non-overlapping the edge, up to and coincidental with the edge, or past the edge.

The grounding plane 902 is a structure for providing an electrical reference point and a source or a sink for electrical radio frequency currents for the dielectric resonator antenna 802. The grounding plane 902 can include the grounding flex 308 of FIG. 3 or a separate structure. The grounding plane 902 can be a metal end-cap on the dielectric resonator antenna 802. The dielectric resonator antenna 802 can be attached or integrated to the ceramic housing 326 of FIG. 3 with or without the grounding plane 902.

The resonator portion 904 and the further portion 906 are structures having specific dielectric characteristics and oscillation characteristics for communication. The resonator portion 904 and the further portion 906 can oscillate for transmitting, receiving, or a combination of functions thereof for wireless signals.

The resonator portion 904, the further portion 906, or a combination thereof can have a resonator width 908. The resonator width 908 can be a measure of size or a dimension for the resonator portion 904, the further portion 906, or a combination thereof. The resonator width 908 can be the same for both the resonator portion 904 and the further portion 906 or different between the resonator portion 904, the further portion 906.

The resonator portion 904 can have a portion length 910 representing a measure of size or a dimension for the resonator portion 904 orthogonal to the resonator width 908 along a horizontal plane. The further portion 906 can have a further length 912 a measure of size or a dimension for the further portion 906 orthogonal to the resonator width 908 along a horizontal plane. The portion length 910 and the further length 912 can be measured along the same direction. The portion length 910 and the further length 912 can be the same or different from each other.

The micro-strip 804 can have a strip width 914 along a direction parallel to the resonator width 908. The micro-strip 804 can have an overhang length 916. The overhang length 916 can be measured from an edge of the resonator portion 904 or the further portion 906 to an edge of the micro-strip 804 along a direction orthogonal to the edge of the resonator portion 904 or the further portion 906, the edge of the micro-strip 804, or a combination thereof. The overhang length 916 can be measured along a direction same as the portion length 910 and the further length 912.

The resonator width 908, the portion length 910, the further length 912, the strip width 914, the overhang length 916, or a combination thereof can be controlled during the manufacturing process, such as by cutting, forming, shaping, placing, attaching, or a combination thereof. The resonator width 908, the portion length 910, the further length 912, the strip width 914, the overhang length 916, or a combination thereof can be controlled for the multi-feed DRA, for the resonant modes or bands, or a combination thereof.

The resonator width 908, the portion length 910, the further length 912 or a combination thereof can be associated with the antenna arrangement 204 of FIG. 2, the antenna location 202 202 of FIG. 2, or a combination thereof. The resonator portion 904, the further portion 906, or a combination thereof can be located in the pocket 410 of FIG. 4, embedded in or integrated with the ceramic housing 326, or a combination thereof as described above.

Referring now to FIG. 10, therein is shown a side view of the dielectric resonator antenna 802. The dielectric resonator antenna 802 can include a metal plate 1002 between the resonator portion 904 of FIG. 9 and the further portion 906 of FIG. 9.

The resonator portion 904, the further portion 906, the metal plate 1002, or a combination thereof can have a resonator height 1004. The resonator height 1004 can be measured from an edge or a surface of the grounding plane 902 of FIG. 9 or the micro-strip 804 of FIG. 8, an edge or a surface of the resonator portion 904 or the further portion 906, or a combination thereof to an edge or a surface of the resonator portion 904 or the further portion 906 opposite thereto. The resonator height 1004 can be measured along a direction orthogonal to the plane including the portion length 910 of FIG. 9 and the resonator width 908 of FIG. 9.

The grounding plane 902 can include a grounding height 1006. The grounding height 1006 can be measured from a surface or an edge to an opposing surface or an opposing edge on the grounding plane 902. The grounding height 1006 can be measured along a line parallel to the resonator height 1004.

The resonator portion 904 can include a resonator dielectric characteristic 1008. The resonator dielectric characteristic 1008 is a measurement of electrically isolative or conductive property for the resonator portion 904. The further portion 906 can include a further dielectric characteristic 1010 corresponding to the further portion 906. The grounding plane 902 can include a grounding dielectric characteristic 1012 corresponding thereto.

The resonator dielectric characteristic 1008 and the further dielectric characteristic 1010 can be the same or different from each other. The resonator dielectric characteristic 1008 and the further dielectric characteristic 1010 can be a relatively high dielectric constant. The grounding dielectric characteristic 1012 can be different from the resonator dielectric characteristic 1008 and the further dielectric characteristic 1010. The grounding dielectric characteristic 1012 can be a relatively low dielectric constant.

The protrusion height 602 of FIG. 6 can be based on the resonator height 1004, the pocket depth 412 of FIG. 4, or a combination thereof. The protrusion height 602 can be a difference between the resonator height 1004 and the pocket depth 412. The antenna-dielectric characteristic 324 of FIG. 3 can be based on the resonator dielectric characteristic 1008, the further dielectric characteristic 1010, or a combination thereof.

Referring now to FIG. 11, therein is shown a functional block diagram for the communication system 100. The communication system 100 can include a control unit 1102, a storage unit 1104, a user interface 1106, a communication unit 1108, or a combination thereof.

The control unit 1102 can be coupled to the storage unit 1104, the user interface 1106, the communication unit 1108, or a combination thereof. The control unit 1102, the storage unit 1104, the user interface 1106, the communication unit 1108, or a combination thereof can further include an internal interface for interacting with each other within the communication system 100.

The control unit 1102 can be implemented in a number of different manners. For example, the control unit 1102 can be a processor, an application specific integrated circuit (ASIC) an embedded processor, a microprocessor, a hardware control logic, a hardware finite state machine (FSM), a digital signal processor (DSP), or a combination thereof. The control unit 1102 can execute any instructions or steps stored in the storage unit 1104, initiated through the user interface 1106, communicated through the communication unit 1108, or a combination thereof.

The user interface 1106 allows a user (not shown) to interface and interact with the communication system 100. The user interface 1106 can include an input device, an output device, or a combination thereof. For example, the user interface 1106 can include a keypad, a touchpad, soft-keys, a keyboard, a microphone, an infrared sensor for receiving remote signals, or any combination thereof to provide data and communication inputs. Also for example, the user interface 1106 can include a display, a projector, a video screen, a speaker, or any combination thereof.

The storage unit 1104 can store software, relevant information, such as data representing incoming images, data representing previously presented image, sound files, or a combination thereof. The storage unit 1104 can be a volatile memory, a nonvolatile memory, an internal memory, an external memory, or a combination thereof. For example, the storage unit 1104 can be a nonvolatile storage such as non-volatile random access memory (NVRAM), Flash memory, disk storage, or a volatile storage such as static random access memory (SRAM).

The communication unit 1108 can enable external communication to and from the communication system 100. The communication unit 1108 can permit the communication system 100 to exchange data with other devices or systems. The communication unit 1108 can also function as a communication hub allowing the communication system 100 to function as part of a communication path and not limited to be an end point or terminal unit in the communication path. The communication unit 1108 can include active and passive components for interaction with the communication path.

For example, the communication unit 1108 can include a short range unit 1110, a long range unit 1112, the antenna unit 312, or a combination thereof. The short range unit 1110 can include circuitry with active components, passive components, or a combination thereof for communicating within a relatively short distance from the communication system 100, as predetermined by the communication system 100, a standard, or a combination thereof. For example, the short range unit 1110 can be for Bluetooth or wireless fidelity (WiFi) communication.

The long range unit 1112 can include circuitry with active components, passive components, or a combination thereof for communicating within a relatively longer distance from the communication system 100, as predetermined by the communication system 100, a standard, or a combination thereof. For example, the long range unit 1112 can be for cellular or satellite communication.

The short range unit 1110, the long range unit 1112, or a combination thereof can be for transmitting, receiving, processing, or a combination thereof for wireless signals. The short range unit 1110, the long range unit 1112, or a combination thereof can transmit or receive using the antenna unit 312 as described above. The short range unit 1110, the long range unit 1112, or a combination thereof can process the information detected by the antenna unit 312.

The functional units in the communication system 100 can work individually and independently of the other functional units. The communication system 100 can work individually and independently from other devices or systems coupled thereto.

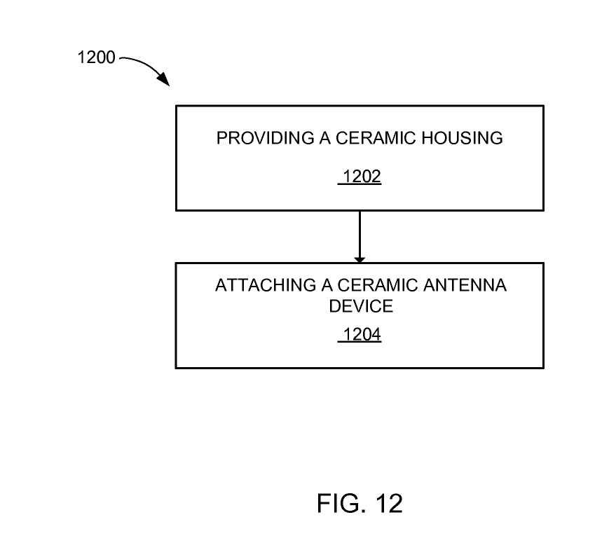

Referring now to FIG. 12, therein is shown a flow chart of a method 1200 of operation of a communication system 100 in an embodiment of the present invention. The method 1200 includes: providing a ceramic housing in a block 1202; and attaching a ceramic antenna device to the ceramic housing in a block 1204.

It has been discovered that the communication system 100 including the ceramic housing 326 provides increased structural integrity and robustness. It has been discovered that the ceramic antenna device 316 attached directly to the ceramic housing 326 provides increased efficiency for transmitting and receiving wireless signals through increasing robustness and performance for the ceramic antenna device 316. It has also been discovered that the ceramic antenna device 316 attached to the ceramic housing 326 can decrease the size of the communication system 100.

It has been discovered that the ceramic antenna device 316 integrated into the ceramic housing 326 provides simpler manufacturing process with increased performance for transmitting and receiving the wireless signal. It has further been discovered that the ceramic antenna device 316 and the ceramic housing 326 provide improved efficiency in manufacturing the communication system 100. It has been discovered that the ceramic antenna device 316 formed in the pocket 410 provides increased efficiency for manufacturing the communication system 100.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A communication system comprising:
a ceramic housing; and
a ceramic antenna device attached to the ceramic housing.

2. The system as claimed in claim 1 further comprising an adhesive between the ceramic housing and the ceramic antenna device for attaching the ceramic antenna device and the ceramic housing.

3. The system as claimed in claim 1 further comprising an additional ceramic-material between the ceramic housing and the ceramic antenna device for attaching the ceramic antenna device and the ceramic housing.

4. The system as claimed in claim 1 wherein the ceramic antenna device is embedded into the ceramic housing.

5. The system as claimed in claim 1 wherein:
the ceramic housing having a housing-processing temperature associated therewith for processing the ceramic housing; and
the ceramic antenna device having an antenna-processing temperature associated therewith, the antenna-processing temperature less than the housing-processing temperature for processing the ceramic antenna device.

6. A communication system comprising:
a ceramic housing including a bottom planar portion with a pocket concave below an inner surface of the bottom planar portion; and
a ceramic antenna device in the pocket and directly attached to the ceramic housing.

7. The system as claimed in claim 6 further comprising an adhesive in the pocket and between the ceramic housing and the ceramic antenna device for attaching the ceramic antenna device directly to the ceramic housing.

8. The system as claimed in claim 6 further comprising an additional ceramic-material between the ceramic housing and the ceramic antenna device for attaching the ceramic antenna device directly to the ceramic housing.

9. The system as claimed in claim 6 wherein:
the ceramic housing includes the pocket having a pocket depth extending below the inner surface; and
the ceramic antenna device includes an antenna height for the ceramic antenna device and a protrusion height extending above the inner surface, the protrusion height based on the pocket depth and the antenna height.

10. The system as claimed in claim 6 wherein the ceramic antenna device is a low temperature co-fired ceramic antenna.

11. A method of manufacture of a communication system comprising:
providing a ceramic housing; and
attaching a ceramic antenna device to the ceramic housing.

12. The method as claimed in claim 11 wherein attaching the ceramic antenna device includes using an adhesive between the ceramic housing and the ceramic antenna device for attaching the ceramic antenna device and the ceramic housing.

13. The method as claimed in claim 11 wherein attaching the ceramic antenna device includes using an additional ceramic-material between the ceramic housing and the ceramic antenna device for attaching the ceramic antenna device and the ceramic housing.

14. The method as claimed in claim 11 wherein attaching the ceramic antenna device includes embedding the ceramic antenna device into the ceramic housing.

15. The method as claimed in claim 11 wherein:
providing the ceramic housing includes providing the ceramic housing having a housing-processing temperature associated therewith for processing the ceramic housing; and
further comprising:
providing the ceramic antenna device having an antenna-processing temperature associated therewith, the antenna-processing temperature less than the housing-processing temperature for processing the ceramic antenna device.

16. The method as claimed in claim 11 wherein:
providing the ceramic housing includes providing the ceramic housing including a bottom planar portion with a pocket concave below an inner surface of the bottom planar portion; and
attaching the ceramic antenna device includes attaching the ceramic antenna device in the pocket and directly to the ceramic housing.

17. The method as claimed in claim 16 wherein attaching the ceramic antenna device includes:
adding an adhesive on the pocket; and
placing the ceramic antenna device on the adhesive and in the pocket, the adhesive between the ceramic housing and the ceramic antenna device for attaching the ceramic antenna device directly to the ceramic housing.

18. The method as claimed in claim 16 wherein attaching the ceramic antenna device includes:
adding an additional ceramic-material on the pocket;
placing the ceramic antenna device on the additional ceramic-material and in the pocket, the additional ceramic-material between the ceramic housing and the ceramic antenna device; and
heating the ceramic antenna device and the additional ceramic-material for attaching the ceramic antenna device directly to the ceramic housing.

19. The method as claimed in claim 16 wherein:
providing the ceramic housing includes providing the ceramic housing with the pocket having a pocket depth extending below the inner surface; and
attaching the ceramic antenna device includes attaching the ceramic antenna device including an antenna height for the ceramic antenna device and a protrusion height extending above the inner surface, the protrusion height based on the pocket depth and the antenna height.

20. The method as claimed in claim 16 wherein attaching the ceramic antenna device includes attaching a low temperature co-fired ceramic antenna.

21. The method as claimed in claim 16 wherein providing the ceramic housing includes forming the pocket on the ceramic housing.

22. The method as claimed in claim 16 wherein:
providing the ceramic housing includes forming the ceramic housing before attaching the ceramic antenna device; and
further comprising:
forming the ceramic antenna device separate from forming the ceramic housing.

23. The method as claimed in claim 16 wherein attaching the ceramic antenna device includes forming the ceramic antenna device in the pocket.
